(19) United States
(12) Patent Application Publication
(10) Pub. No.: US 2024/0241301 A1
(43) Pub. Date: Jul. 18, 2024

(54) POLARIZING PLATE AND OPTICAL DISPLAY APPARATUS

(71) Applicant: SAMSUNG SDI CO., LTD., Yongin-si (KR)

(72) Inventors: Jung Hun YOU, Suwon-si (KR); Sang Hum LEE, Suwon-si (KR); Jun Mo KOO, Suwon-si (KR); Seong Hoon LEE, Suwon-si (KR); Seon Gyeong JEONG, Suwon-si (KR); Dong Ho WEE, Suwon-si (KR)

(21) Appl. No.: 18/414,083

(22) Filed: Jan. 16, 2024

(30) Foreign Application Priority Data
Jan. 16, 2023 (KR) 10-2023-0006038

(51) Int. Cl. G02B 5/30; G02B 1/04

(52) U.S. Cl. CPC G02B 5/3083; G02B 1/04; G02F 1/133634

(57) ABSTRACT

A polarizing plate and an optical display apparatus including the same are provided. A polarizing plate includes: a polarizer; and a stack of retardation layers on at least one surface of the polarizer, and the stack of retardation layers includes a second retardation layer, a primer layer, and a first retardation layer stacked in sequence on the polarizer, and the primer layer has a glass transition temperature of 60° C. to 150° C. and is a (meth)acrylate-based primer layer.

### CROSS-REFERENCE TO RELATED APPLICATION

The present application claims priority to and the benefit of Korean Patent Application No. 10-2023-0006038, filed on Jan. 16, 2023 in the Korean Intellectual Property Office, the entire disclosure of which is incorporated herein by reference.

### BACKGROUND

### 1. Field

Aspects of embodiments of the present invention relate to a polarizing plate and an optical display apparatus including the same.

### 2. Description of the Related Art

A liquid crystal panel having a liquid crystal layer is an essential component of a liquid crystal display apparatus. Among operation modes of the liquid crystal layer, a lateral electric field mode is a mode that causes response of a liquid crystal compound in an in-plane direction of a substrate of the liquid crystal panel by an electric field including a component generally parallel to a plane of the substrate. Such a lateral electric field mode includes an in-plane switching (IPS) mode and a fringe-field switching (FFS) mode. In the lateral electric field mode, a retardation layer is disposed between the liquid crystal panel and a polarizer to increase contrast ratio and viewing angle and minimize or reduce color shift.

Although the retardation layer may be a single layer, a stack of retardation layers including multiple retardation layers is commonly used. Here, the multiple retardation layers are laminated into a stack using an interlayer adhesive, which can make it difficult to reduce the thickness of a polarizing plate and can increase manufacturing costs. Therefore, a primer layer between the retardation layers may be considered. However, if the retardation layers are formed of different materials having different properties or if the retardation layers are formed by different manufacturing methods using the same material, this can cause a difference in physical properties and/or physicochemical properties, such as glass transition temperature, between the retardation layers, causing reduction in peel strength between the retardation layers after leaving the polarizing plate under high temperature conditions and/or under high temperature and high humidity conditions. In addition, if a composition for the primer layer has poor compatibility with the retardation layer, phase separation between the composition and the retardation layer can occur upon coating the composition onto the retardation layer, causing increased haze and decreased light transmittance.

The background technique of the present invention is disclosed in Korean Patent Laid-open Publication No. 10-2013-0103595.

### SUMMARY

According to an aspect of embodiments of the present invention, a polarizing plate that includes a stack of retardation layers having good interlayer peel strength and low haze and thus good optical transparency is provided.

According to another aspect of embodiments of the present invention, a polarizing plate that includes a stack of retardation layers having good reliability under water at high temperature, under high temperature conditions, and under high temperature and high humidity conditions is provided.

According to another aspect of embodiments of the present invention, a polarizing plate that has good reliability under high temperature conditions and under high temperature and high humidity conditions is provided.

According to an aspect of the present invention, a polarizing plate is provided.

According to one or more embodiments, a polarizing plate includes: a polarizer; and a stack of retardation layers on at least one surface of the polarizer, wherein the stack of retardation layers includes a second retardation layer, a primer layer, and a first retardation layer stacked in sequence on the polarizer, and the primer layer has a glass transition temperature of 60° C. to 150° C. and is a (meth)acrylate-based primer layer.

According to another aspect of the present invention, an optical display apparatus is provided.

The optical display apparatus includes the polarizing plate according to the present invention.

One or more embodiments of the present invention provide a polarizing plate that includes a stack of retardation layers having good interlayer peel strength and low haze and thus good optical transparency.

Further, one or more embodiments of the present invention provide a polarizing plate that includes a stack of retardation layers having good reliability under water at high temperature, under high temperature conditions, and under high temperature and high humidity conditions.

Further, one or more embodiments of the present invention provide a polarizing plate that has good reliability under high temperature conditions and under high temperature and high humidity conditions.

### BRIEF DESCRIPTION OF THE DRAWINGS

FIG. 1 is a cross-sectional view of a polarizing plate according to an embodiment of the present invention.

FIG. 2 is a cross-sectional view of a polarizing plate according to another embodiment of the present invention.

### DETAILED DESCRIPTION

Herein, some example embodiments of the present invention will be described in further detail with reference to the accompanying drawings such that the present invention can be implemented by those skilled in the art. It is to be understood that the present invention may be embodied in different ways and is not limited to the following embodiments. In the drawings, portions irrelevant to the description may be omitted for clarity. Like components are denoted by like reference numerals throughout the specification. Lengths, sizes, and the like of components in the drawings are shown for the purpose of illustrating the invention, and the invention is not limited thereto.

The terminology used herein is for the purpose of describing some example embodiments and is not intended to limit the present invention. As used herein, the singular forms “a,” “an,” and “the” are intended to include the plural forms as well, unless the context clearly indicates otherwise.

As used herein, “in-plane retardation (Re),” “out-of-plane retardation (Rth),” and “degree of biaxiality (NZ)” are represented by the following Equations A, B, and C, respectively:

$$Re = ( n x - n y ) \times d \qquad ( A )$$

$$Rth = ( ( n x + ny ) / 2 - nz ) \times d \qquad ( B )$$

$$NZ = ( n x - nz ) / ( nx - ny ) , \qquad ( C )$$

where nx, ny, and nz are indexes of refraction of an optical element in the slow-axis direction, the fast-axis direction, and the thickness direction of the optical element at a measurement wavelength, respectively, and d is the thickness (unit: nm) of the optical element. In Equations A to C, the measurement wavelength may be 450 nm, 550 nm, or 650 nm.

As used herein, “haze” is measured using a haze meter at a wavelength of 380 nm to 780 nm, and refers to an average haze measured in the wavelength range unless clearly stated otherwise and refers to a total haze unless clearly stated otherwise.

As used herein, nx, ny, and nz refer to the indexes of refraction of an optical element in the slow-axis direction (a direction in which the index of refraction of the optical element in the in-plane direction attains a maximum level), the fast-axis direction (a direction in which the index of refraction of the optical element in the in-plane direction attains a minimum level), and the thickness direction of the optical element, at a wavelength of 550 nm, respectively, unless clearly stated otherwise.

As used herein to represent an angle, “+” means the counterclockwise direction about a reference point and “−” means the clockwise direction about the reference point.

As used herein, “(meth)acrylic” may refer to acrylic and/or methacrylic.

As used herein to represent a specific numerical range, “X to Y” means “greater than or equal to X and less than or equal to Y (X≤ and ≤Y).”

A polarizing plate according to the present invention includes a stack of retardation layers on at least one surface of a polarizer. The stack of retardation layers includes a second retardation layer, a primer layer, and a first retardation layer.

In an embodiment, the second retardation layer is a positive C layer and the first retardation layer is a positive A layer, wherein the polarizing plate may be used in an optical display apparatus, for example, a liquid crystal display apparatus, and, in an embodiment, a horizontal alignment mode liquid crystal display apparatus, such as an IPS or FFS mode liquid crystal display, to increase contrast ratio and viewing angle while minimizing or reducing color shift.

With the primer layer interposed between the first retardation layer and the second retardation layer, the stack of retardation layers has good peel strength between the first retardation layer and the second retardation layer, low haze and good optical transparency, high reliability under water at high temperature, high reliability under high temperature conditions, and high reliability under high temperature and humidity conditions.

The primer layer is formed by applying a composition for the primer layer to at least one of the first retardation layer and the second retardation layer, followed by drying and/or curing. Here, there is no phase separation between the composition for the primer layer and the retardation layer with the composition applied thereto, resulting in low haze and high optical transparency. In addition, the primer layer is a (meth)acrylate-based primer layer having a glass transition temperature in a specific range as described below, thereby increasing peel strength between the first retardation layer and the second retardation layer described below and improving reliability of the stack of retardation layers.

A polarizing plate according to the present invention includes a polarizer and a stack of retardation layers formed on at least one surface of the polarizer, wherein the stack of retardation layers includes a second retardation layer, a primer layer, and a first stack of retardation layer stacked in sequence on the polarizer and the primer layer has a glass transition temperature of 60° C. to 150° C. and is a (meth)acrylate-based primer layer.

Herein, the polarizing plate according to embodiments of the present invention will be described in further detail.

### Stack of Retardation Layers

The stack of retardation layers includes a second retardation layer, a primer layer, and a first retardation layer stacked in sequence on the polarizer.

In an embodiment, the stack of retardation layers may have a haze of 0.3% or less, for example, 0.01% to 0.3% or 0.01% to 0.2%. Within this range, the stack of retardation layers may not affect light emitted from a panel of a display apparatus, thereby improving optical efficiency.

The stack of retardation layers has good interlayer peel strength between the first retardation layer and the second retardation layer, thereby securing high reliability under water at high temperature, under high temperature conditions and under high temperature and humidity conditions. In an embodiment, the polarizing plate may have an interlayer peel strength of 300 gf/25 mm or more, for example, 300 gf/25 mm to 900 gf/25 mm, or 300 gf/25 mm to 700 gf/25 mm, or 300 gf/25 mm to 600 gf/25 mm, between the first retardation layer and the second retardation layer. Within this range, the stack of retardation layers can have good reliability under water at high temperature, under high temperature conditions, and under high temperature and high humidity conditions. Herein, “peel strength” may be measured as described in Experimental Example.

### First Retardation Layer

The first retardation layer is a positive A layer (nx>ny=nz) and serves to improve contrast ratio and viewing angle and minimize or reduce color shift in combination with the second retardation layer, which is a positive C layer, when the polarizing plate is used in an IPS or FFS mode liquid crystal display apparatus.

The first retardation layer may have a Re of 100 nm to 160 nm at a wavelength of 550 nm. Within this range, in combination with the second retardation layer, the first retardation layer can improve contrast ratio and viewing angle of an IPS mode liquid crystal display apparatus while minimizing or reducing color shift of the liquid crystal display apparatus. For example, the first retardation layer may have a Re of 100 nm, 105 nm, 110 nm, 115 nm, 120 nm, 125 nm, 130 nm, 135 nm, 140 nm, 145 nm, 150 nm, 155 nm, or 160 nm, and, in an embodiment, 110 nm to 150 nm, and, in an embodiment, 120 nm to 140 nm.

In an embodiment, the first retardation layer may have an Rth of 50 nm to 80 nm at a wavelength of 550 nm. Within this range, it may be ensured that the first retardation layer has a Re within the range set forth above and has a reduced thickness. For example, the first retardation layer may have an Rth of 50 nm, 55 nm, 60 nm, 65 nm, 70 nm, 75 nm, or 80 nm.

In an embodiment, the first retardation layer may have an NZ of 0.9 to 1.1 at a wavelength of 550 nm. Within this range, it may be ensured that the first retardation layer has a Re within the range set forth above. For example, the first retardation layer may have an NZ of 0.9, 0.95, 1.0, 1.05, or 1.1.

In an embodiment, the positive A layer may have an Re(450)-to-Re(550) ratio (Re(450)/Re(550)) of less than 1.05, for example, 0.8 to less than 1.05. In an embodiment, the positive A layer may have an Re(650)-to-Re(550) ratio (Re(650)/Re(550)) of greater than 0.97, for example, greater than 0.97 to 1.1. Within this range, it may be ensured that the positive A layer has negative dispersion or flat dispersion.

In an embodiment, the first retardation layer as the positive A layer may have negative dispersion or flat dispersion. Herein, “negative dispersion” means that the in-plane retardation of the positive A layer increases with increasing wavelength.

In an embodiment, the first retardation layer may have an Re of 105 nm to 165 nm, and, in an embodiment, 100 nm to 163 nm, at a wavelength of 650 nm, and an Re of 95 nm to 155 nm, and, in an embodiment, 96 nm to 153 nm, at a wavelength of 450 nm. Within these ranges, it may be ensured that the first retardation layer has an Re(450)-to-Re(550) ratio and an Re(650)-to-Re(550) ratio within the ranges set forth above.

In an embodiment, the first retardation layer may have a total light transmittance of 90% or more, for example, 90% to 100%, and a haze of 0.3% or less, for example, 0% to 0.3% or 0.1% to 0.3%. Within these ranges, the first retardation layer can be used in the stack of retardation layers.

The first retardation layer may have a thickness of 70 μm or less, for example, greater than 0 μm to 70 μm, or 5 μm to 70 μm, or 20 μm to 70 μm, and, in an embodiment, 20 μm to 50 μm. Within this range, the first retardation layer can be used in the polarizing plate.

The first retardation layer may be a non-liquid crystalline film and may include a stretched film formed of an optically transparent resin. Herein, “non-liquid crystalline film” may refer to a film that is not formed of any of a liquid crystal monomer, a liquid crystal oligomer, and a liquid crystal polymer, or a film formed of a material that is not converted to a liquid crystal monomer, a liquid crystal oligomer, or a liquid crystal polymer upon irradiation with light.

For example, the first retardation layer may be a film formed of at least one selected from among cellulose based resins, such as triacetyl cellulose, polyester based resins, such as polyethylene terephthalate (PET), polybutylene terephthalate, polyethylene naphthalate, and polybutylene naphthalate, cyclic olefin copolymer (COC) based resins, cyclic olefin polymer (COP) based resins, polycarbonate based resins, polyether sulfone based resins, polysulfone based resins, polyamide based resins, polyimide based resins, polyolefin based resins, polyarylate based resins, polyvinyl alcohol based resins, polyvinyl chloride based resins, polyvinylidene chloride based resins, and acrylic based resins.

In an embodiment, the first retardation layer may include a cyclic olefin polymer (COP) based film, a cyclic olefin copolymer (COC) based film, or an acrylic based film to facilitate adjustment of compatibility with the primer layer described below. In particular, the cyclic olefin polymer (COP) based film can be effective in improving contrast ratio and viewing angle and minimizing or reducing color shift when the polarizing plate according to the present invention is used in an IPS or FFS mode liquid crystal display apparatus.

The first retardation layer may be a hydrophobic film. For example, the hydrophobic film may include at least one selected from among a cyclic olefin polymer (COP) based film and a cyclic olefin copolymer (COC) based film.

In an embodiment, the first retardation layer may include a film formed of a resin having a positive intrinsic birefringence.

In an embodiment, the first retardation layer may have a glass transition temperature of 100° C. or greater, for example, 100° C., 105° C., 110° C., 115° C., 120° C., 125° C., 130° C., 135° C., 140° C., 145° C., or 150° C., and, in an embodiment, 100° C. to 150° C., or 100° C. to 130° C. Within this range, the polarizing plate can have further improved durability. The glass transition temperature of the first retardation layer may be adjusted by adjusting the type of resin in a composition for the first retardation layer, the weight average molecular weight of the resin, the type and/or content of monomers in the resin, and the like.

The first retardation layer may be a film prepared by uniaxially stretching a non-stretched film for the first retardation layer in the MD (machine direction) or TD (transverse direction) or in a direction oblique to the MD. In an embodiment, the first retardation layer may be a film prepared by uniaxially stretching a non-stretched film for the first retardation layer in a direction oblique to the MD. Here, stretching conditions, such as an elongation, a stretching temperature, and a stretching method, may be adjusted such that the first retardation layer has an Re within the range set forth above at a wavelength 550 nm.

The non-stretched film for the first retardation layer may be prepared by melt extrusion or solution casting of the composition for the first retardation layer, without being limited thereto. Here, melt extrusion or solution casting may be carried out under typical conditions known to those skilled in the art.

The first retardation layer has an in-plane slow axis and an in-plane fast axis, the slow axis of the first retardation layer may be substantially parallel to a light absorption axis of the polarizer. For example, assuming the light absorption axis of the polarizer is 0°, the slow axis of the first retardation layer may be at an angle of −5° to 5°, and, in an embodiment, −0.5° to 0.5° or 0°.

### Second Retardation Layer

The second retardation layer is a positive C layer (nz>nx=ny) and may serve to improve contrast ratio and viewing angle and minimize or reduce color shift in combination with the first retardation layer, which is the positive A layer, when the polarizing plate is used in an IPS or FFS mode liquid crystal display apparatus.

In an embodiment, the second retardation layer may have an Rth of −140 nm to −10 nm at a wavelength of 550 nm. Within this range, the second retardation layer can improve contrast ratio and viewing angle of an IPS mode liquid crystal display apparatus while minimizing or reducing color shift of the liquid crystal display apparatus. For example, the second retardation layer may have an Rth of −140 nm, −130 nm, −120 nm, −110 nm, −100 nm, −90 nm, −80 nm, −70 nm, −60 nm, −50 nm, −40 nm, −30 nm, −20 nm, or −10 nm, and, in an embodiment, −120 nm to −45 nm, and, in an embodiment, −100 nm to −65 nm.

In an embodiment, the second retardation layer may have an Re of 10 nm or less, for example, 0 nm to 10 nm, at a wavelength of 550 nm. Within this range, it may be ensured that the second retardation layer has an Rth within the range set forth above.

In an embodiment, the second retardation layer may have a total light transmittance of 90% or more, for example, 90% to 100%, and a haze of 0.3% or less, for example, 0% to 0.3% or 0.1% to 0.3%. Within these ranges, the second retardation layer can be used in the stack of retardation layers.

In an embodiment, the second retardation layer may have a thickness of 10 μm or less, for example, greater than 0 μm to 10 μm, 1 μm to 10 μm, 2 μm to 7 μm, or 3 μm to 4 μm. Within this range, the stack of retardation layers can have a reduced thickness.

The second retardation layer has a lower index of refraction than the first retardation layer. For example, the second retardation layer may have an index of refraction of 1 to 2, and, in an embodiment, 1.4 to 1.6, and, in an embodiment, 1.5 to 1.6.

The second retardation layer may be formed of a different material than the first retardation layer. In an embodiment, the second retardation layer may be formed of a material that has a different birefringence than the first retardation layer, is hydrophobic, and has a negative intrinsic birefringence.

The second retardation layer may include a polystyrene based polymer as a main component. In an embodiment, the polystyrene based polymer may contain a halogen. According to the present invention, the second retardation layer may be formed of a composition for the second retardation layer including a halogen-containing polystyrene based polymer to ensure that the second retardation layer has an Rth within the range set forth above, the wavelength dispersion described above, and a reduced thickness. As used herein, “polymer” is used to refer to an oligomer, copolymer, or a resin. In addition, “main component” refers to a component that is present in an amount of 95 wt % or more, or 95 wt % to 99 wt %, based on the total weight of the second retardation layer. In addition, the second retardation layer including the halogen-containing polystyrene polymer can be easily adjusted in compatibility with the primer layer described below.

The halogen may be fluorine, chlorine, iodine, or bromine, and, in an embodiment, fluorine.

The halogen-containing polystyrene based polymer may include a repeat unit represented by Formula 1:

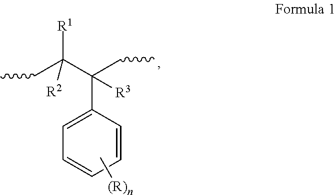

where, in Formula 1, [symbol] is a binding site, R¹, R², and R³ are each independently hydrogen, an alkyl group, a substituted alkyl group, or a halogen, each R is independently an alkyl group, a substituted alkyl group, a halogen, a hydroxyl group, a carboxyl group, a nitro group, an alkoxy group, an amino group, a sulfonate group, a phosphate group, an acyl group, an acyloxy group, a phenyl group, an alkoxycarbonyl group, or a cyano group, at least one of R¹, R², and R³ is a halogen and/or at least one R is a halogen, and n is an integer of 0 to 5.

The halogen-containing polystyrene based polymer may be formed, for example, by polymerization of a mixture including at least one selected from among 1-(2,2-difluoroethenyl)-2-fluorobenzene and 1′,2′,2′-trifluorostyrene.

In an embodiment, the second retardation layer may have a higher glass transition temperature than the first retardation layer. This contributes to increased durability of the polarizing plate by inhibiting elution of iodine from the polarizer under high temperature and humidity conditions. Further, this facilitates providing all the desired effects of the present invention in combination with the primer layer having a glass transition temperature in a specific range described below.

In an embodiment, the second retardation layer may have a glass transition temperature of 130° C. or greater, for example, 130° C., 140° C., 150° C., 160° C., 170° C., 180° C., 190° C., 200° C., 210° C., 220° C., 230° C., 240° C., or 250° C., and, in an embodiment, 130° C. to 250° C., or 130° C. to 230° C. The glass transition temperature of the second retardation layer within the range set forth above may be achieved by adjusting the weight average molecular weight, halogen content, and polymerization conditions of the halogen-containing polystyrene based polymer, without being limited thereto.

The composition for the second retardation layer may further include a halogen-free styrene based polymer, for example, halogen-free polystyrene.

The composition for the second retardation layer may further include an additive. The additive may adjust wavelength dispersion. The additive may include a fused aromatic ring-containing additive, such as any of 2-naphthylbenzoate, anthracene, phenanthrene, and 2,6-naphthalenedicarboxylic acid diester. In an embodiment, the fused aromatic ring-containing additive may be present in an amount of 0.1 wt % to 30 wt %, and, in an embodiment, 1 wt % to 10 wt %, in the composition for the second retardation layer. Within this range, the fused aromatic ring-containing additive can adjust retardation expression and wavelength dispersion.

The composition for the second retardation layer may further include typical additives known to those skilled in the art. The additives may include any of a pigment, an antioxidant, an antistatic agent, and a heat stabilizer, without being limited thereto.

The second retardation layer may be a cured layer, such as a cured coating layer cured by thermal curing or photocuring, and may be prepared by any typical method known to those skilled in the art.

The first retardation layer and the second retardation layer may be stacked on a lower surface of the polarizer to improve contrast ratio and viewing angle of an IPS mode liquid crystal display apparatus and minimize or reduce color shift of the liquid crystal display apparatus. However, since the first retardation layer and the second retardation layer are formed of different materials, there is a high possibility of occurrence of interlayer delamination between the first retardation layer and the second retardation layer. Although a pressure sensitive adhesive (PSA) or the like may be used to adhesively bond the first retardation layer to the second retardation layer, this can cause an increase in thickness of the stack of retardation layers and an increase in manufacturing cost.

The primer layer according to embodiments of the present invention is formed on a surface of the first retardation layer or the second retardation layer to increase interlayer peel strength between the first retardation layer and the second retardation layer, improve optical transparency of the stack of retardation layers through reduction in haze of the stack of retardation layers, improve reliability of the stack of retardation layers under water at high temperature, under high temperature conditions, and under high temperature and high humidity conditions, and improve reliability of the polarizing plate under high temperature conditions and under high temperature and high humidity conditions.

### Primer Layer

In an embodiment, the primer layer has a glass transition temperature of 60° C. to 150 ° C. Within this range, the primer layer can easily secure an interlayer peel strength of 300 gf/25 mm or greater when interposed between the first retardation layer and the second retardation layer, thereby improving reliability of the stack of retardation layers. For example, the primer layer may have a glass transition temperature of 60° C., 70° C., 80° C., 90° C., 100° C., 110° C., 120° C., 130° C., 140° C., or 150° C., and, in an embodiment, 60° C. to 90° C., and, in an embodiment, 60° C. to 70° C.

The primer layer is a (meth)acrylate-based primer layer. The (meth)acrylate-based primer layer can easily secure an interlayer peel strength of 300 gf/25 mm or greater when interposed between the first retardation layer and the second retardation layer and can avoid increase in haze due to good compatibility with both the first retardation layer and the second retardation layer formed of the materials described above.

In an embodiment, the primer layer may be a (meth)acrylate-based primer layer not modified with a styrene based compound or a (meth)acrylate-based primer layer modified with a styrene based compound. In an embodiment, the primer layer may be a (meth)acrylate-based primer layer modified with a styrene based compound. In this way, the primer layer can have further improved peel strength with respect to the first retardation layer and the second retardation layer.

When the primer layer is a (meth)acrylate-based primer layer having a glass transition temperature of 60° C. to 150° C., the primer layer can secure an interlayer peel strength of 300 gf/25 mm or greater between the first retardation layer and the second retardation layer, can improve optical transparency of the stack of retardation layers through reduction in haze of the stack of retardation layers, can improve reliability of the stack of retardation layers under water at high temperature, under high temperature conditions, and under high temperature and high humidity conditions, and can improve reliability of the polarizing plate under high temperature conditions and under high temperature and high humidity conditions. If the glass transition temperature of the primer layer is less than 60° C., this can cause poor reliability of the stack of retardation layers under water at high temperature and poor reliability of the polarizing plate under high temperature conditions and under high temperature and high humidity conditions.

Herein, the (meth)acrylate-based primer layer may refer to a primer layer that includes a (meth)acrylic based copolymer as a main component thereof. Herein, the expression “including a (meth)acrylic based copolymer as a main component” means that the (meth)acrylic based copolymer or a cured product thereof is present in an amount of 95 wt % or more, for example, 98 wt % to 100 wt % or 99 wt % to 100 wt %, in the primer layer or in a composition for the primer layer in terms of solid content.

In an embodiment, the (meth)acrylate-based primer layer may include 5 wt % or less, and, in an embodiment, 0 wt % to 1 wt % or 0 wt % of a urethane based compound, a urethane (meth)acrylate based compound, a urethane ester based compound, a polyester based compound, or a silane based compound.

The (meth)acrylate-based primer layer may be formed of a photocurable composition or a thermocurable composition.

A composition for the (meth)acrylate-based primer layer may include a (meth)acrylic based copolymer and a curing agent.

To provide the primer layer having a glass transition temperature within the range set forth above, a monomer mixture for preparation of the (meth)acrylic based copolymer may include a (meth)acrylic based monomer having a high homopolymer glass transition temperature. For example, the (meth)acrylic based monomer may have a homopolymer glass transition temperature of 10° C. or more, for example, 10° C. to 100° C., 50° C. to 80° C., or 60° C. to 70° C. Within this range, it is easy to ensure that the primer layer has a glass transition temperature within the range set forth above and it may be easy to increase interlayer peel strength between the first retardation layer and the second retardation layer. Herein, “homopolymer glass transition temperature” may be determined by any typical method known to those skilled in the art or by referring to a catalog published by a manufacturer of the (meth)acrylic based monomer.

In an embodiment, the (meth)acrylic based monomer may include at least one selected from among a (meth)acrylic acid ester containing a C₁ to C₁₀ alkyl group, a (meth)acrylic acid ester containing a C₁ to C₁₀ alkyl group having a hydroxyl group, and a (meth)acrylic acid ester containing a C₅ to C₁₀ alicyclic group.

In an embodiment, the (meth)acrylic based monomer may include at least one selected from among methyl methacrylate, butyl methacrylate, hydroxyethyl methacrylate, cyclohexyl methacrylate, and 2-ethylhexyl methacrylate. For example, the (meth)acrylic based monomer may be a (meth)acrylic acid ester containing an alkyl group, for example, a (meth)acrylic acid ester containing a C₁ to C₁₀ alkyl group, which can increase interlayer peel strength between the first retardation layer and the second retardation layer, which are hydrophobic.

In an embodiment, the monomer mixture for preparation of the (meth)acrylic based copolymer may include 20 parts by weight to 80 parts by weight, for example, 20 parts by weight, 25 parts by weight, 30 parts by weight, 35 parts by weight, 40 parts by weight, 45 parts by weight, 50 parts by weight, 55 parts by weight, 60 parts by weight, 65 parts by weight, 70 parts by weight, 75 parts by weight, or 80 parts by weight, and, in an embodiment, 20 parts by weight to 60 parts by weight, or 20 parts by weight to 50 parts by weight, of the (meth)acrylic monomer having a homopolymer glass transition temperature of 10° C. or more, relative to 100 parts by weight of the monomer mixture. Within this range, the primer layer can easily provide the desired effects of the present invention.

In addition to the (meth)acrylic based monomer having a homopolymer glass transition temperature of 10° C. or greater, the monomer mixture may further include a peel strength-enhancing compound that can increase the interlayer peel strength.

The peel strength-enhancing compound may increase interlayer peel strength by providing a modified (meth)acrylic based copolymer through polymerization with the (meth)acrylic monomer having a homopolymer glass transition temperature of 10° C. or greater or by providing a modified (meth)acrylic based copolymer through modification of a side chain of the (meth)acrylic based monomer having a homopolymer glass transition temperature of 10° C. or greater. The modified (meth)acrylic based copolymer formed through polymerization of the peel strength-enhancing compound with the (meth)acrylic based monomer having a homopolymer glass transition temperature of 10° C. or greater may be a random copolymer, a block copolymer, an alternating copolymer, or a graft copolymer thereof, and, in an embodiment, a block copolymer of the peel strength-enhancing compound and the (meth)acrylic based monomer having a homopolymer glass transition temperature of 10° C. or greater.

The peel strength-enhancing compound may include at least one selected from among a (meth)acrylate based compound, an ester based compound, and a styrene based compound.

The (meth)acrylate based compound may include at least one selected from the group consisting of alkyl (meth)acrylates, cycloalkyl (meth)acrylates, and non-cycloalkyl (meth)acrylates. Herein, “alkyl” may refer to a C₁ to C₁₀ alkyl group, “cycloalkyl” may refer to a C₃ to C₁₀ cycloalkyl group, and “non-cycloalkyl” may refer to a C₅ to C₂₀ non-cycloalkyl group.

For example, the (meth)acrylate based compound may include at least one selected from monoesters of (meth)acrylic acid with C₁ to C₂₀ monoalcohols, including methyl (meth)acrylate, ethyl (meth)acrylate, n-propyl (meth)acrylate, isopropyl (meth)acrylate, n-butyl (meth)acrylate, isobutyl (meth)acrylate, t-butyl (meth)acrylate, n-hexyl (meth)acrylate, 2-ethylhexyl (meth)acrylate, isobornyl (meth)acrylate, cyclohexyl (meth)acrylate, n-octyl (meth)acrylate, n-heptyl (meth)acrylate, lauryl (meth)acrylate, and stearyl (meth)acrylate, without being limited thereto.

The ester based compound may improve interlayer peel strength and may be selected from a formic acid ester based compound, an acetic acid ester based compound, or a (meth)acrylic acid ester based compound, including butyl acetic ester, butyl formic ester, cyclohexyl 2-methyl-propenoic ester, 2-methylcyclohexyl 2-propenoic ester, isopropyl acetate, and the like.

The styrene based compound may include styrene, methyl styrene, and the like. The styrene based compound may further increase peel strength between the primer layer and the second retardation layer. In an embodiment, the styrene based compound may be present in an amount of 0 parts by weight to 10 parts by weight, for example, greater than 0 parts by weight to 10 parts by weight or 0.1 parts by weight to 5 parts by weight, relative to 100 parts by weight of the monomer mixture.

In an embodiment, the monomer mixture may include methyl methacrylate and cyclohexyl 2-methyl-2-propenoic ester.

In another embodiment, the monomer mixture may include methyl methacrylate, cyclohexyl 2-methyl-2-propenoic ester, butyl acetic ester, butyl formic ester, and styrene.

The monomer mixture may further include a comonomer. The comonomer may be a compound containing a polymeric unsaturated bond aside from a hydroxyl group and an alkyl (meth)acrylate ester monomer and may include, for example, at least one selected from among (meth)acrylamide; a carboxyl group-containing monomer, such as maleic acid; an epoxy group-containing monomer, such as glycidyl (meth)acrylate; (meth)acrylonitrile; vinyl acetate; and vinyl chloride.

In an embodiment, the peel strength-enhancing compound may be present in an amount of 20 parts by weight to 80 parts by weight, for example, 40 parts by weight to 80 parts by weight or 50 parts by weight to 80 parts by weight, relative to 100 parts by weight of the monomer mixture. Within this range, the peel strength-enhancing compound can increase interlayer peel strength without affecting the glass transition temperature of the primer layer.

Each of the (meth)acrylic based copolymer and the modified (meth)acrylic based copolymer may be formed by any typical polymerization method known to those skilled in the art.

The composition for the primer layer may further include at least one selected from among a peel strength-enhancing compound and a curing agent.

The peel strength-enhancing compound may include the peel strength-enhancing compound described above. The peel strength-enhancing compound may be present in an amount of 0 parts by weight to 10 parts by weight, for example, greater than 0 parts by weight to 5 parts by weight, relative to 100 parts by weight of the (meth)acrylic based copolymer or the modified (meth)acrylic based copolymer. Within this range, the peel strength-enhancing compound can increase interlayer peel strength through increase in interlayer adhesion without affecting the glass transition temperature of the primer layer.

The curing agent may further increase peel strength of the primer layer by curing the (meth)acrylic based copolymer or the modified (meth)acrylic based copolymer. The curing agent may be appropriately selected depending on the type of monomers contained in the (meth)acrylic based copolymer or the modified (meth)acrylic based copolymer. For example, the curing agent is a thermal curing agent and may include an isocyanate based curing agent. The isocyanate curing agent may include at least one selected from among hexamethylene diisocyanate and octamethylene diisocyanate.

In an embodiment, the curing agent may be present in an amount of 0.1 parts by weight to 10 parts by weight, for example, 0.1 parts by weight, 1 part by weight, 2 parts by weight, 3 parts by weight, 4 parts by weight, 5 parts by weight, 6 parts by weight, 7 parts by weight, 8 parts by weight, 9 parts by weight, or 10 parts by weight, and, in an embodiment, 0.1 parts by weight to 5 parts by weight or 1 part by weight to 2 parts by weight, relative to 100 parts by weight of the (meth)acrylic based copolymer in terms of solid content. Within this range, good interlayer peel strength can be achieved while preventing or substantially preventing reduction in optical transparency due to an excess of the isocyanate curing agent.

The primer layer may further include typical additives known to those skilled in the art, in addition to the components described above.

In an embodiment, the composition for the primer layer may be a solvent-free composition.

In another embodiment, the composition for the primer layer may further include a solvent. Organic solvents can dissolve the first retardation layer or the second retardation layer or can cause poor haze and poor compatibility of the primer layer, whereas aqueous solvents do not cause these problems. Such an aqueous solvent may include water such as ultrapure water, without being limited thereto. The aqueous solvent may be present in the balance amount in the composition. In the present invention, the primer layer is formed using the composition including the aqueous solvent, thereby increasing peel strength between the first retardation layer and the second retardation layer while improving compatibility of the primer layer with the first retardation layer and the second retardation layer and thus preventing or substantially preventing an increase in haze.

In an embodiment, the primer layer may have a thickness of 500 nm or less, for example, greater than 0 nm to 500 nm, 100 nm to 500 nm, or 200 nm to 400 nm. Within this range, the primer layer can ensure reliable adhesion between the first retardation layer and the second retardation layer.

In the stack of retardation layers, each of the first retardation layer and the second retardation layer may be formed directly on the primer layer. Accordingly, the primer layer can ensure reliable adhesion between the first retardation layer and the second retardation layer through increase in interlayer peel strength between the first retardation layer and the second retardation layer, thereby eliminating the need to dispose an adhesive layer or a bonding layer, such as a pressure sensitive adhesive layer, between the first retardation layer and the primer layer, between the second retardation layer and the primer layer, and/or between the first retardation layer and the second retardation layer.

The primer layer may be formed first on a surface of the first retardation layer or on a surface of the second retardation layer. In an embodiment, the stack of retardation layers is formed by applying the composition for the primer layer to a surface of the first retardation layer to a thickness (e.g., a predetermined thickness), followed by curing to form the primer layer, and then applying the composition for the second retardation layer to a surface of the primer layer to a thickness (e.g., a predetermined thickness), followed by curing, although not particularly limited thereto. Here, a method to apply the compositions and a method to cure the compositions may be varied depending on the composition of the primer layer.

### Polarizer

The polarizer may convert incident natural light or polarized light into light linearly polarized in a specific direction. In an embodiment, the polarizer may have a thickness of 2 μm to 30 μm, and, in an embodiment, 4 μm to 25 μm. Within this range, the polarizer can be used in the polarizing plate.

The polarizer may be fabricated using a film including a polyvinyl alcohol based resin as a main component by any typical method known to those skilled in the art. For example, the polarizer may be fabricated by dyeing the film with iodine, followed by stretching. The polarizer has an in-plane light absorption axis and an in-plane light transmission axis orthogonal to the light absorption axis, wherein the light absorption axis may correspond to the MD of the polarizer and the light transmission axis may correspond to the TD of the polarizer.

In an embodiment, the polarizing plate may include the polarizer and the stack of retardation layers formed on a lower surface of the polarizer. Herein, the “lower surface of the polarizer” may refer to a light incidence surface of the polarizer, through which light emitted from a liquid crystal panel enters the polarizer.

The polarizing plate may further include at least one protective layer formed on an upper surface of the polarizer, between the polarizer and the stack of retardation layers, and/or on the lower surface of the polarizer, wherein the protective layer may be any typical protective layer for polarizing plates known in the art.

The protective layer may include at least one selected from among an optically transparent protective coating layer and an optically transparent protective film. The protective coating layer may include a coating layer formed of a composition including an actinic radiation-curable compound. The protective film is an optically transparent film and may include, for example, a film formed of at least one selected from among cellulose based resins, such as triacetylcellulose (TAC), polyester based resins, such as polyethylene terephthalate (PET), polybutylene terephthalate, polyethylene naphthalate, and polybutylene naphthalate, cyclic polyolefin based resins, polycarbonate based resins, polyethersulfone based resins, polysulfone based resins, polyamide based resins, polyimide based resins, polyolefin based resins, polyarylate based resins, polyvinyl alcohol based resins, polyvinyl chloride based resins, and polyvinylidene chloride based resins. In an embodiment, the protective film may be a TAC film or a PET film.

In an embodiment, the protective layer may have a thickness of 0.1 μm to 100 μm, and, in an embodiment, 5 μm to 70 μm, and, in an embodiment, 15 μm to 45 μm. Within this range, the protective layer can be used in the polarizing plate.

The protective layer may be attached to an adherend via a bonding layer. The protective layer may be omitted if omission of the protective layer does not impair the function of the polarizing plate.

The polarizing plate may further include an adhesive layer on a lowermost surface thereof. The adhesive layer may adhesively bond the polarizing plate to a panel of an optical display apparatus. The adhesive layer may be formed of any typical adhesive composition known to those skilled in the art.

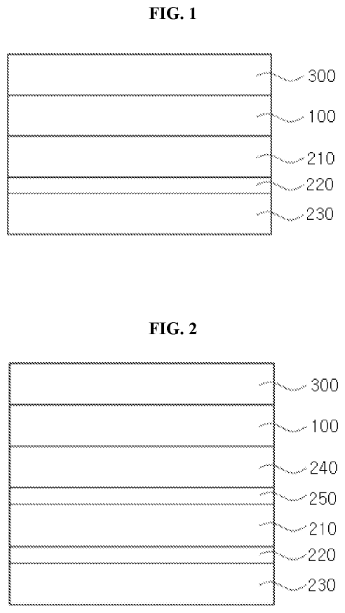

Referring to FIG. 1, a polarizing plate according to an embodiment of the present invention includes: a polarizer 100; a first protective layer 300 formed on an upper surface of the polarizer 100; and a stack of retardation layers formed on a lower surface of the polarizer 100, wherein the stack of retardation layers includes a second retardation layer 210, a primer layer 220, and a first retardation layer 230 stacked in sequence on the polarizer 100.

Referring to FIG. 2, a polarizing plate according to another embodiment of the present invention includes: a polarizer 100; a first protective layer 300 formed on an upper surface of the polarizer 100; and a second protective layer 240, an adhesive layer 250, and a stack of retardation layers stacked in sequence on a lower surface of the polarizer 100, wherein the stack of retardation layers includes a second retardation layer 210, a primer layer 220, and a first retardation layer 230 stacked in sequence on the polarizer 100.

### Optical Display Apparatus

An optical display apparatus according to the present invention includes the polarizing plate according to an embodiment of the present invention. The optical display apparatus may include a liquid crystal display apparatus. The polarizing plate according to the present invention may be used as a viewer-side polarizing plate of the optical display apparatus. In an embodiment, the liquid crystal display apparatus may be an IPS or FFS mode liquid crystal display apparatus.

In an embodiment, the liquid crystal display apparatus may include a liquid crystal panel, a viewer-side polarizing plate disposed at a side of the liquid crystal panel, and a light source-side polarizing plate disposed at another side of the liquid crystal panel. A light absorption axis of a polarizer of the viewer-side polarizing plate may be substantially orthogonal to a light absorption axis of the light source-side polarizing plate. Assuming the light absorption axis of the polarizer of the viewer-side polarizing plate is 0°, the light absorption axis of the light source-side polarizing plate may be at an angle of 90° and a rubbing direction of a liquid crystal of the liquid crystal panel may be at an angle of 90°.

Next, the present invention will be described in further detail with reference to some examples. However, it is to be understood that these examples are provided for illustration and are not to be construed in any way as limiting the present invention.

### Example 1

10 parts by weight of AIBN as a polymerization initiator was added to a total of 200 parts by weight of a monomer mixture prepared by mixing 100 parts by weight of methyl methacrylate (homopolymer glass transition temperature: 60° C.), 100 parts by weight of cyclohexyl 2-methyl-2-propenoic ester, 0 parts by weight of butyl acetic ester, and 0 parts by weight of butyl formic ester, followed by polymerization at 70° C. for 10 hours, thereby preparing a (meth)acrylic based copolymer. In terms of solid content, 2 parts by weight of hexamethylene diisocyanate (HDI) was added to and mixed with 100 parts by weight of the (meth)acrylic based copolymer, thereby preparing a solvent-free composition for a primer layer.

The prepared primer layer composition was applied to a predetermined thickness to an upper surface of a cyclic olefin polymer based (COP) film (positive A layer, ZD series, Zeon Co., Ltd.) obliquely stretched at an angle of 45° with respect to the MD, followed by drying and thermal curing, thereby forming a primer layer on the upper surface of the COP film.

A composition for a second retardation layer (including a fluorine-containing polystyrene based polymer) was applied to an upper surface of the primer layer, followed by drying and curing to form a second retardation layer (positive C layer) on the upper surface of the primer layer, thereby fabricating a stack of retardation layers in which a layer containing the fluorine-containing polystyrene based polymer as the second retardation layer (positive C layer, Rth at a wavelength of 550 nm: −100 nm, thickness: 3 μm, glass transition temperature: 210° C.), the primer layer (thickness: 300 nm), and the COP film as the first retardation layer (positive A layer, Re at a wavelength of 550 nm: 130 nm, thickness: 50 μm, glass transition temperature: 120° C.) were stacked in the stated order.

A polyvinyl alcohol based film (TS #20, Kuraray Co., Ltd., Japan, pre-stretching thickness: 20 μm) was uniaxially stretched to 6 times an original length thereof in the MD in an aqueous solution of iodine having 55° C., thereby fabricating a polarizer having a light transmittance of 45%.

A polyethylene terephthalate (PET) film with an antireflection later formed thereon was laminated on an upper surface of the polarizer, followed by laminating the stack of retardation layers on a lower surface of the polarizer with the positive C layer closer to the polarizer than the positive A layer, thereby fabricating a polarizing plate.

### Example 2

10 parts by weight of AIBN as a polymerization initiator was added to a total of 100 parts by weight of a monomer mixture prepared by mixing 60 parts by weight of methyl methacrylate, 20 parts by weight of cyclohexyl 2-methyl-2-propenoic ester, 10 parts by weight of butyl acetic ester, 5 parts by weight of butyl formic ester, and 5 parts by weight of styrene, followed by polymerization at 70° C. for 10 hours, thereby preparing a (meth)acrylic based copolymer. In terms of solid content, 2 parts by weight of hexamethylene diisocyanate (HDI) was added to and mixed with 100 parts by weight of the (meth)acrylic based copolymer, thereby preparing a solvent-free composition for a primer layer. A polarizing plate was fabricated in the same manner as in Example 1 except that the prepared primer layer composition was used.

### Example 3

10 parts by weight of AIBN as a polymerization initiator was added to a total of 100 parts by weight of a monomer mixture prepared by mixing 50 parts by weight of methyl methacrylate, 20 parts by weight of cyclohexyl 2-methyl-2-propenoic ester, 20 parts by weight of butyl acetic ester, 5 parts by weight of butyl formic ester, and 5 parts by weight of styrene, followed by polymerization at 70° C. for 10 hours, thereby preparing a (meth)acrylic based copolymer. In terms of solid content, 2 parts by weight of hexamethylene diisocyanate (HDI) was added to and mixed with 100 parts by weight of the (meth)acrylic based copolymer, thereby preparing a solvent-free composition for a primer layer. A polarizing plate was fabricated in the same manner as in Example 1 except that the prepared primer layer composition was used.

### Example 4

10 parts by weight of AIBN as a polymerization initiator was added to a total of 100 parts by weight of a monomer mixture prepared by mixing 20 parts by weight of methyl methacrylate, 30 parts by weight of cyclohexyl 2-methyl-2-propenoic ester, 30 parts by weight of butyl acetic ester, 10 parts by weight of butyl formic ester, and 10 parts by weight of styrene, followed by polymerization at 70° C. for 10 hours, thereby preparing a (meth)acrylic based copolymer. In terms of solid content, 2 parts by weight of hexamethylene diisocyanate (HDI) was added to and mixed with 100 parts by weight of the (meth)acrylic based copolymer, thereby preparing a solvent-free composition for a primer layer. A polarizing plate was fabricated in the same manner as in Example 1 except that the prepared primer layer composition was used.

### Comparative Example 1

A polarizing plate was fabricated in the same manner as in Example 1 except that a polyester-based composition was used as a composition for a primer layer.

### Comparative Example 2

A polarizing plate was fabricated in the same manner as in Example 1 except that a urethane-based composition (700P, UCC Co., Ltd.) was used as a composition for a primer layer.

### Comparative Example 3

A polarizing plate was fabricated in the same manner as in Example 1 except that a urethane-based composition (701U, UCC Co., Ltd.) was used as a composition for a primer layer.

### Comparative Example 4

A polarizing plate was fabricated in the same manner as in Example 1 except that a urethane-based composition (702U, UCC Co., Ltd.) was used as a composition for a primer layer.

### Comparative Example 5

A polarizing plate was fabricated in the same manner as in Example 1 except that a urethane ester-based composition (550P, UCC Co., Ltd.) was used as a composition for a primer layer.

### Comparative Example 6

A polarizing plate was fabricated in the same manner as in Example 1 except that a urethane ester-based composition (551P, UCC Co., Ltd.) was used as a composition for a primer layer.

### Comparative Example 7

A polarizing plate was fabricated in the same manner as in Example 1 except that a silane-based composition (307S, UCC Co., Ltd.) was used as a composition for a primer layer.

### Comparative Example 8

10 parts by weight of AIBN as a polymerization initiator was added to a total of 100 parts by weight of a monomer mixture prepared by mixing 60 parts by weight of methyl methacrylate, 15 parts by weight of cyclohexyl 2-methyl-2-propenoic ester, 15 parts by weight of butyl acetic ester, and 10 parts by weight of butyl formic ester, followed by polymerization at 25° C. for 7 hours, thereby preparing a (meth)acrylic based copolymer. In terms of solid content, 2 parts by weight of hexamethylene diisocyanate (HDI) was added to and mixed with 100 parts by weight of the (meth)acrylic based copolymer, thereby preparing a solvent-free composition for a primer layer. A polarizing plate was fabricated in the same manner as in Example 1 except that the prepared primer layer composition was used.

### Comparative Example 9

10 parts by weight of AIBN as a polymerization initiator was added to a total of 100 parts by weight of a monomer mixture prepared by mixing 60 parts by weight of methyl methacrylate, 15 parts by weight of cyclohexyl 2-methyl-2-propenoic ester, 15 parts by weight of butyl acetic ester, and 10 parts by weight of butyl formic ester, followed by polymerization at 40° C. for 10 hours, thereby preparing a (meth)acrylic based copolymer. In terms of solid content, 2 parts by weight of hexamethylene diisocyanate (HDI) was added to and mixed with 100 parts by weight of the (meth)acrylic based copolymer, thereby preparing a solvent-free composition for a primer layer. A polarizing plate was fabricated in the same manner as in Example 1 except that the prepared primer layer composition was used.

### Comparative Example 10

10 parts by weight of AIBN as a polymerization initiator was added to a total of 100 parts by weight of a monomer mixture prepared by mixing 60 parts by weight of methyl methacrylate, 15 parts by weight of cyclohexyl 2-methyl-2-propenoic ester, 15 parts by weight of butyl acetic ester, and 10 parts by weight of butyl formic ester, followed by polymerization at 50° C. for 10 hours, thereby preparing a (meth)acrylic based copolymer. In terms of solid content, 2 parts by weight of hexamethylene diisocyanate (HDI) was added to and mixed with 100 parts by weight of the (meth)acrylic based copolymer, thereby preparing a solvent-free composition for a primer layer. A polarizing plate was fabricated in the same manner as in Example 1 except that the prepared primer layer composition was used.

### Comparative Example 11

10 parts by weight of AIBN as a polymerization initiator was added to 100 parts by weight of methyl acrylate, followed by polymerization at 25° C. for 7 hours, thereby preparing a (meth)acrylic based copolymer. In terms of solid content, 2 parts by weight of hexamethylene diisocyanate (HDI) was added to and mixed with 100 parts by weight of the (meth)acrylic based copolymer, thereby preparing a solvent-free composition for a primer layer. A polarizing plate was fabricated in the same manner as in Example 1 except that the prepared primer layer composition was used.

Each of the stack of retardation layers and the polarizing plates fabricated in Examples 1 to 4 and Comparative Examples 1 to 11 was evaluated as to the following properties. Results are shown in Table 1.

(1) Glass transition temperature of primer layer (unit: ° C.): Primer layers were prepared in the same manner as in Examples 1 to 4 and Comparative Examples 1 to 11. Glass transition temperature of each of the primers layer was measured by differential scanning calorimetry (DSC).

(2) Haze of stack of retardation layers (Unit: %): Haze (total haze) of each of the respective stack of retardation layers of the polarizing plates fabricated in Examples 1 to 4 and Comparative Examples 1 to 11 was measured at a wavelength of 380 nm to 780 nm using a haze meter (Nippon Denshoku Industries Co., Ltd.).

(3) Peel strength (unit: gf/25 mm): Each of the stack of retardation layers fabricated in Examples 1 to 4 and Comparative Examples 1 to 11 was cut to a size of 25 mm×100 mm, thereby preparing a sample, and then the sample was attached to an alkali-free glass plate with an adhesive (PSA) using a laminator such that the positive A layer of the sample was laminated on the glass plate. Thereafter, the sample was compressed in an autoclave (at 50° C. and 5 atmospheres) for about 20 minutes and then stored in a constant temperature and humidity chamber (at 23° C. and 50% RH) for 4 hours. Thereafter, peel strength was measured using a peel strength tester (Texture Analyzer, Stable Micro-System Ltd., UK) under conditions of a temperature of 25° C., a peeling rate of 300 mm/min, and a peeling angle of 180°. Specifically, with the COP film of the sample secured with a clip of the peel strength tester, interlayer peel strength between the positive C layer and the positive A layer was measured by pulling the positive C layer off of the positive A layer at an angle of 180° with constant force.

(4) Cross-cut adhesion of positive C layer: Adhesion of the positive C layer was evaluated by a cross-cut test method. Each of the stack of retardation layers fabricated in Examples 1 to 4 and Comparative Examples 1 to 11 was cut into a square having a size of 10 cm×10 cm (length×width) and then the square was divided into a 10×10 grid of 100 square cells by cutting up to the positive C layer along horizontal and vertical lines. An adhesive tape (NICHIBAN, Com. General Consumables) was attached to the surface of the positive C layer and then detached therefrom, followed by counting the number of cells remaining without being peeled off. A larger number of remaining cells indicates better peel strength. When the number of remaining cells was 100, a corresponding sample was rated as 5B, when the number of remaining cells was 80 to less than 100, a corresponding sample was rated as 4B, when the number of remaining cells was 60 to less than 80, a corresponding sample was rated as 3B, when the number of remaining cells was 40 to less than 60, a corresponding sample was rated as 2B, and, when the number of remaining cells was less than 40, a corresponding sample was rated as 1B.

4) Reliability of stack of retardation layers: Each of the stack of retardation layers fabricated in Examples 1 to 4 and Comparative Examples 1 to 11 was cut into a square with a size of 10 cm×10 cm (length×width) and then left under the following conditions. Thereafter, when there was no delamination between the positive A layer and the positive C layer, a corresponding sample was rated as “o” and, when there was any delamination between the positive A layer and the positive C layer, a corresponding sample was rated as “x”.

(i) The stack of retardation layers was completely immersed in water at 85° C. and then left for 1 hour.

(ii) The stack of retardation layers was left in a constant temperature and humidity chamber at 85° C. for 1 hour.

(iii) The stack of retardation layers was left in a constant temperature and humidity chamber at 85° C. and 85% RH for 1 hour.

(5) Reliability of polarizing plate: Each of the polarizing plates fabricated in Examples 1 to 4 and Comparative Examples 1 to 11 was cut into a square having a size of 10 cm×10 cm (length×width) and then left under the following conditions.

Thereafter, when there was no delamination between the positive A layer and the positive C layer, a corresponding sample was rated as “o” and, when there was any delamination between the positive A layer and the positive C layer, a corresponding sample was rated as “x”.

(i) The polarizing plate was left in a constant temperature and humidity chamber at 85° C. for 1 hour.

(ii) The polarizing plate was left in a constant temperature and humidity chamber at 85° C. and 85% RH for 1 hour.

TABLE 1

| | | | | Stack of retardation layers | | | | | | Polarizing plate | |
|---|---|---|---|---|---|---|---|---|---|---|---|
| | Primer layer | | | | Peel | Cross-cut | Reliability | Reliability | Reliability | Reliability | Reliability |
| | Type | Tg | Thickness | Haze | strength | adhesion | (i) | (ii) | (iii) | (i) | (ii) |
| Example 1 | Methacrylate | 60 | 300 | 0.1 | 300 | 5B | ◯ | ◯ | ◯ | ◯ | ◯ |
| Example 2 | Styrene - | 60 | 200 | 0.2 | 500 | 5B | ◯ | ◯ | ◯ | ◯ | ◯ |
| | modified | | | | | | | | | | |
| | methacrylate | | | | | | | | | | |
| Example 3 | Styrene - | 70 | 200 | 0.2 | 600 | 5B | ◯ | ◯ | ◯ | ◯ | ◯ |
| | modified | | | | | | | | | | |
| | methacrylate | | | | | | | | | | |
| Example 4 | Styrene - | 90 | 200 | 0.2 | 650 | 5B | ◯ | ◯ | ◯ | ◯ | ◯ |
| | modified | | | | | | | | | | |
| | methacrylate | | | | | | | | | | |
| Comparative | Polyester | 45 | 200 | 0.4 | 60 | 4B | X | X | X | X | X |
| Example 1 | | | | | | | | | | | |
| Comparative | Urethane | −20 | 200 | 0.3 | 71 | 4B | ◯ | X | X | X | X |
| Example 2 | | | | | | | | | | | |
| Comparative | Urethane | 0 | 200 | 0.3 | 103 | 4B | ◯ | ◯ | ◯ | X | X |
| Example 3 | | | | | | | | | | | |
| Comparative | Urethane | 65 | 200 | 0.3 | 104 | 4B | X | ◯ | ◯ | X | X |
| Example 4 | | | | | | | | | | | |
| Comparative | Urethane | 10 | 200 | 0.3 | 50 | 4B | ◯ | X | X | X | X |
| Example 5 | ester | | | | | | | | | | |
| Comparative | Urethane | 65 | 200 | 0.3 | 50 | 4B | ◯ | X | X | X | X |
| Example 6 | ester | | | | | | | | | | |
| Comparative | Silane | 65 | 200 | 0.2 | 50 | 4B | ◯ | X | X | X | X |
| Example 7 | | | | | | | | | | | |
| Comparative | Methacrylate | 0 | 200 | 0.2 | 200 | 5B | X | ◯ | ◯ | X | X |
| Example 8 | | | | | | | | | | | |
| Comparative | Methacrylate | 20 | 200 | 0.2 | 250 | 5B | X | ◯ | ◯ | X | X |
| Example 9 | | | | | | | | | | | |
| Comparative | Methacrylate | 50 | 200 | 0.2 | 250 | 5B | X | ◯ | ◯ | X | X |
| Example 10 | | | | | | | | | | | |
| Comparative | Acrylate | 20 | 200 | 0.2 | 300 | 5B | X | ◯ | ◯ | X | X |
| Example 11 | | | | | | | | | | | |

As shown in Table 1, the stack of retardation layers of the polarizing plates according to the present invention had good interlayer peel strength, low haze and good optical transparency, and high reliability under water at high temperature, under high temperature conditions, and under high temperature and high humidity conditions. Further, the polarizing plates according to the present invention had high reliability under high temperature conditions and under temperature and high humidity conditions.

By contrast, the stack of retardation layers and the polarizing plates of the Comparative Examples, which included a non-(meth)acrylate-based primer layer or a (meth)acrylate-based primer layer having a glass transition temperature outside the range set forth herein, failed to achieve all the desired effects of the present invention.

Although some example embodiments have been described herein, it is to be understood that various modifications, changes, alterations, and equivalent embodiments can be made by those skilled in the art without departing from the spirit and scope of the invention.

What is claimed is:

1. A polarizing plate comprising:
a polarizer; and
a stack of retardation layers formed on at least one surface of the polarizer,
wherein the stack of retardation layers comprises a second retardation layer, a primer layer, and a first retardation layer stacked in sequence on the polarizer, and
the primer layer has a glass transition temperature of 60° C. to 150° C. and is a (meth)acrylate-based primer layer.

2. The polarizing plate as claimed in claim 1, wherein the primer layer has a glass transition temperature of 60° C. to 90° C.

3. The polarizing plate as claimed in claim 1, wherein a peel strength between the first retardation layer and the second retardation layer is 300 gf/25 mm or greater.

4. The polarizing plate as claimed in claim 1, wherein the primer layer is formed directly on each of the first retardation layer and the second retardation layer.

5. The polarizing plate as claimed in claim 1, wherein the primer layer is a (meth)acrylate-based primer layer not modified with a styrene based compound or a (meth)acrylate-based primer layer modified with a styrene based compound.

6. The polarizing plate as claimed in claim 1, wherein the primer layer is formed of a primer layer composition comprising a copolymer of a monomer mixture comprising a (meth)acrylic based monomer having a homopolymer glass transition temperature of 10° C. or greater.

7. The polarizing plate as claimed in claim 6, wherein the (meth)acrylic based monomer having a homopolymer glass transition temperature of 10° C. or greater comprises at least one selected from among a (meth)acrylic acid ester containing a C₁ to C₁₀ alkyl group, a (meth)acrylic acid ester containing a C₁ to C₁₀ alkyl group having a hydroxyl group, and a (meth)acrylic acid ester containing a C₅ to C₁₀ alicyclic group.

8. The polarizing plate as claimed in claim 6, wherein the monomer mixture further comprises a peel strength-enhancing compound.

9. The polarizing plate as claimed in claim 8, wherein the peel strength-enhancing compound comprises at least one selected from among a (meth)acrylate based compound, an ester based compound, and a styrene based compound.

10. The polarizing plate as claimed in claim 9, wherein the ester based compound comprises at least one selected from among a formic acid ester compound, an acetic acid ester compound, and a (meth)acrylic acid ester compound.

11. The polarizing plate as claimed in claim 10, wherein the ester based compound comprises at least one selected from among butyl acetic ester, butyl formic ester, cyclohexyl 2-methyl-propenoic ester, 2-methylcyclohexyl 2-propenoic ester, and isopropyl acetate.

12. The polarizing plate as claimed in claim 9, wherein the styrene based compound is present in an amount of greater than 0 parts by weight to 10 parts by weight relative to 100 parts by weight of the monomer mixture.

13. The polarizing plate as claimed in claim 8, wherein the monomer mixture comprises 20 parts by weight to 80 parts by weight of the (meth)acrylic based monomer having a homopolymer glass transition temperature of 10° C. or greater and 20 parts by weight to 80 parts by weight of the peel strength-enhancing compound.

14. The polarizing plate as claimed in claim 1, wherein the second retardation layer has a higher glass transition temperature than the first retardation layer.

15. The polarizing plate as claimed in claim 14, wherein the second retardation layer has a glass transition temperature of 130° C. or greater, and the first retardation layer has a glass transition temperature of 100° C. or greater.

16. The polarizing plate as claimed in claim 1, wherein the second retardation layer comprises a polystyrene based polymer, and the first retardation layer is a COP based film, a COC based film, or an acrylic based film.

17. The polarizing plate as claimed in claim 16, wherein the polystyrene based polymer contains a halogen.

18. The polarizing plate as claimed in claim 1, wherein the second retardation layer is a positive C layer, and the first retardation layer is a positive A layer.

19. The polarizing plate as claimed in claim 1, wherein the stack of retardation layers is formed on a light incidence surface of the polarizer.

20. An optical display apparatus comprising the polarizing plate as claimed in claim 1.
